(19) United States
(12) Patent Application Publication
(10) Pub. No.: US 2026/0074123 A1
(43) Pub. Date: Mar. 12, 2026

(54) Lead Frame Comprising a Discontinuous Surface Coating to Improve Capacitor Life

(71) Applicant: KEMET Electronics Corporation, Fort Lauderdale, FL (US)

(72) Inventors: Lie Wu, Suzhou (CN); Lingling Xi, Suzhou (CN); Qingping Chen, Simpsonville, SC (US); Chunsong Sun, Suzhou (CN)

(21) Appl. No.: 18/883,313

(22) Filed: Sep. 12, 2024

(51) Int. Cl. H01G 9/012; C09D 5/24; C09D 165/00; H01G 9/00; H01G 9/042; H01G 9/045; H01G 9/10

(52) U.S. Cl. CPC H01G 9/012; C09D 5/24; C09D 165/00; H01G 9/0029; H01G 9/0425; H01G 9/045; H01G 9/10

(57) ABSTRACT

Provided is a capacitor and method of forming the capacitor. The capacitor comprises a first capacitive couple comprising a first dielectric on a first anode and a first cathode on the first dielectric. The first anode and first cathode are connected to a lead frame comprising a discontinuous surface coating wherein the discontinuous surface coating comprises a contact region and a discontinuous region. At least one of the first anode or the first cathode is in electrical contact at the contact region. An encapsulant is in contact with the lead frame at the discontinuous region.

### BACKGROUND OF THE INVENTION

The present invention is related to a solid electrolytic surface mount capacitor with an improved life. More specifically, the present invention is related to a solid electrolytic capacitor comprising an anode and a cathode which are assembled with a lead frame comprising a discontinuous surface coating wherein the discontinuous surface coating mitigates delamination of the encasement from the lead frame.

Electronic capacitors are well known in the art and widely used. There are myriad capacitor designs. The present invention is specifically related to solid electrolytic capacitors wherein conductive cathodic layers, preferably conductive polymeric cathodic layers, are formed on the dielectric surface. Degradation of the conductive polymers, and other parts of solid electrolytic capacitors by oxygen and moisture under high temperature is one of the major factors limiting the life of such capacitors which limits their use in high temperature applications. The present invention is particularly beneficial in any situation where a solid electrolytic capacitor may experience periods of high temperature whether transient or enduring.

A multiple anode capacitor comprising multiple capacitive elements is illustrated schematically in FIG. 1 wherein the problem solved by the instant invention will be better appreciated. Each capacitive element comprises an anode, 10, in the form of a conductive sheet or foil. A dielectric, not illustrated, encases at least a portion of the anode and preferably the entire anode. A cathode, 12, which is conductive, encompasses at least a portion of the dielectric with the understanding that the cathode and anode are separated by the dielectric and are not in direct physical contact. The anode and cathode, with a dielectric therebetween, forms the capacitive couple as would be understood by those of skill in the art. The anodes are electrically bonded to each other and to an anode lead, 14. The cathodes are also in electrical contact with each other and are collectively in electrical contact with a cathode lead, 24. The anode lead and cathode lead are collectively referred to herein as a lead frame with the terms anode and cathode being used herein for the purpose of clarity with the understanding that the electrical functionality could be reversed. An encasement, 22, encases the capacitor except for the termination of the cathode lead and anode lead of the lead frame.

In FIG. 1, a capacitor, 8, is shown with the failure mode demonstrated. As would be realized to those of skill in the art a gap, 18, is created between at least a portion of the encasement, 22 and the anode lead, 14. The gap, 18, between the encasement and anode lead provides a point of ingress of environmental components, such as oxygen and water, which is detrimental to the functionality and longevity of the capacitor, especially under high temperature. Such gap, 18, could also happen between the encasement, 22, and the cathode lead, 24.

Many artisans have searched for methods to improve adhesion between the encasement and lead frame. Various compositions have been developed wherein the adhesion between the encasement and lead frame is improved. Yet it is surprising that the problem persists. A commonly utilized approach utilizes etching, mechanical or chemical, of the lead frame to increase the surface area with the expectation that an increased surface area would improve mechanical interlocking between the encasement and lead frame. Mechanical interlocking may be somewhat beneficial, yet it is not been found to be sufficient.

Through diligent research the inventors have discovered a previously unrealized failure mode. With reference to FIG. 2A, the lead frame, represented by an anode lead, typically comprises a surface coating, 20, such as tin. Without being limited by theory, it is hypothesized that when the capacitor is subjected to heat, such as during surface mounting, the temperature of the lead frame increases. With sufficient time and heat the surface coating, 20, begins to flow, or wick, in the direction of the arrow thereby causing wicking of the surface coating from under the encasement, 22. As illustrated in FIG. 2B, after sufficient wicking of the surface coating has occurred the vacated space between the encasement and lead frame creates the gap, 18, which provides the point of ingress of environmental components. Such deterioration of case integrity could happen on the cathode side as well.

The present invention provides an improved capacitor wherein improved case integrity between the encasement and anode or cathode lead is provided.

### SUMMARY OF THE INVENTION

Provided herein is an improved capacitor and, more specifically, a surface mount solid electrolytic capacitor with improved capacitor life due to mitigation of thermally induced deterioration of case integrity between the encasement and anode or cathode lead.

A particular advantage of the present invention is the ability to provide a surface mount solid capacitor which is more resilient with regard to thermal degradation such as that which occurs from reflow, during surface mounting, or thermal transients which occur during normal use.

A particular feature of the present invention is the thermal stability achieved by the instant invention.

These and other advantages, as will be realized, are provided in a capacitor comprising a first capacitive couple comprising a first dielectric on a first anode and a first cathode on the first dielectric. The first anode and first cathode are connected to a lead frame comprising a discontinuous surface coating wherein the discontinuous surface coating comprises a contact region and a discontinuous region. At least one of the first anode or the first cathode is in electrical contact at the contact region. An encapsulant is in contact with said lead frame at said discontinuous region.

Yet another embodiment is provided in a method for forming capacitor comprising:
forming a first capacitive couple comprising a first dielectric on a first anode and a first cathode on the first dielectric;
providing a lead frame comprising a discontinuous surface coating wherein the discontinuous surface coating comprises a contact region and a discontinuous region;
electrically connecting the first anode or first cathode to the contact region; and
encapsulating the capacitive couple with an encapsulant wherein the encapsulant is in contact with the lead frame at the discontinuous region.

### BRIEF DESCRIPTION OF DRAWINGS

FIG. 1 is a schematic cross-sectional representation of a prior art capacitor.

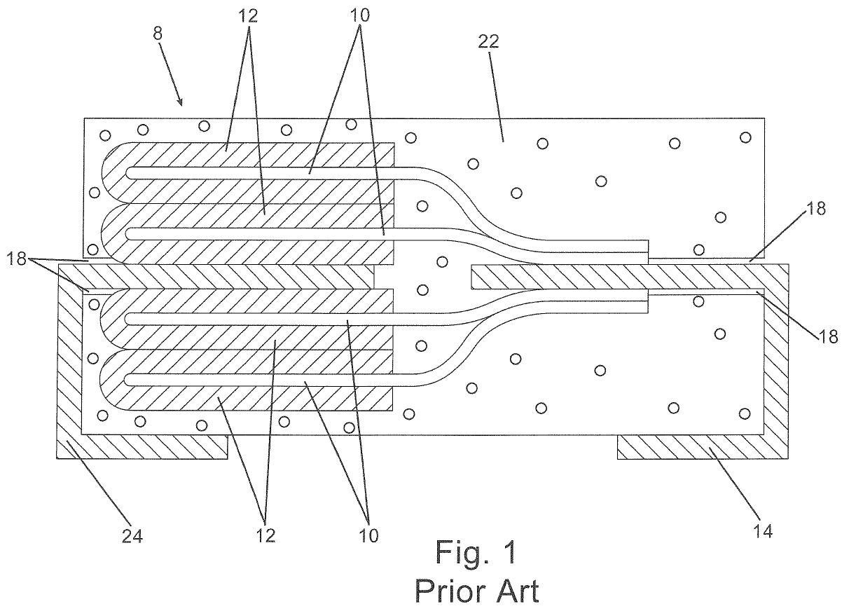

FIGS. 2A and 2B are schematic partial representations of a prior art capacitor.

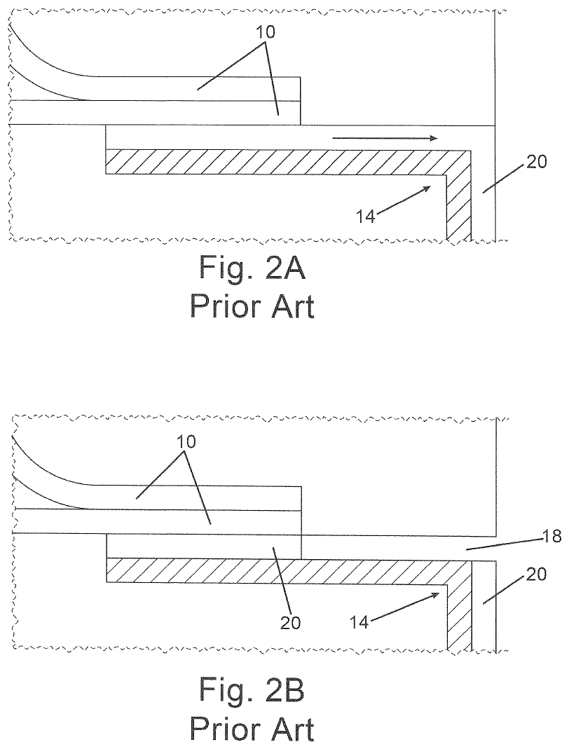

FIG. 3 is a schematic cross-sectional view of an embodiment of the invention.

FIG. 4 is a partial schematic cross-sectional view of an embodiment of the invention.

FIG. 5 is a flow-chart representation of an embodiment of the invention.

FIG. 6 is a schematic cross-sectional view of an embodiment of the invention.

### DETAILED DESCRIPTION OF THE INVENTION

The present invention is related to an improved capacitor, and preferably, an improved surface mount solid electrolytic capacitor. More specifically, the present invention is related to an improved capacitor comprising a lead frame with a discontinuous surface coating on the anode lead and/or cathode lead of the lead frame wherein the discontinuous surface coating inhibits migration of surface coating between the lead frame and encapsulant.

The invention will be described with reference to the figures which are an integral, but non-limiting, part of the specification provided for clarity of the invention. Throughout the various figures similar elements will be numbered according.

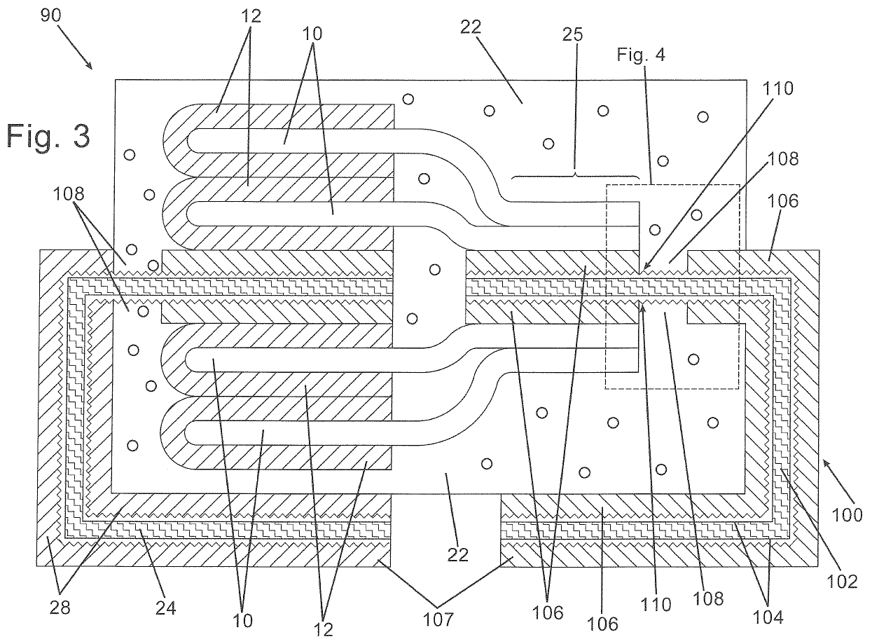

An embodiment of the invention will be described with reference to FIG. 3. In FIG. 3 an embodiment of the invention is illustrated schematically in cross-sectional view.

In FIG. 3, a capacitor, 90, comprises a capacitive element comprising an anode, 10, in the form of a conductive, preferably porous, sheet or foil. A dielectric, not illustrated, encases at least a portion of the anode and preferably the entire anode. A cathode, 12, which is conductive, encompasses at least a portion of the dielectric with the understanding that the cathode and anode are separated by the dielectric and are not in direct contact. The anode and cathode, with a dielectric therebetween, forms the capacitive couple as would be understood to those of skill in the art. The capacitive couple is not particularly limited herein. The anodes are electrically and mechanically bonded to each other at a junction region, 25, and to surface coating, 106, of a discontinuous anode lead, 100, at a contact region which will be further described herein. The cathodes are in electrical contact with each other and are collectively in electrical contact with a cathode lead, 24, comprising an optional but preferred discontinuous cathode surface coating, 28, comprising a discontinuous region, 108, wherein the discontinuous region lacks the surface coating the function of which will be more readily apparent after further discussion. An encasement, 22, encases at least a portion and preferably the entire capacitive couple and capacitor except for a terminal portion of the cathode lead and anode lead forming the lead frame. As would be understood the anode lead and cathode lead are collectively referred to as the lead frame, 107. In FIG. 3, the anode lead and cathode lead are illustrated and annotated differently for the purposes of discussion and clarity. In an embodiment the anode lead and cathode lead are separate portions collectively forming a lead frame and may be indistinguishable. When the anode lead and cathode lead are indistinguishable the discontinuous surface coating of each is substantially the same and the discontinuous region dimensions may be similar. As illustrated in FIG. 3 it is preferable that at least one of the anode lead or cathode lead of the lead frame, and preferably both, comprises a plurality of surface perturbations to increase surface area. It is preferable that the surface perturbations extend at least the length of the discontinuous region. The surface perturbations may be in a repetitive pattern or random without limit to the shape thereof. In a particularly preferred embodiment the surface perturbations are in the form of dimples approximating circular indentions with an average diameter of 5 μm to 500 μm. In another embodiment the surface perturbations may be formed by laser ablation or chemical etching to an average depth of 0.5 μm to 20 μm.

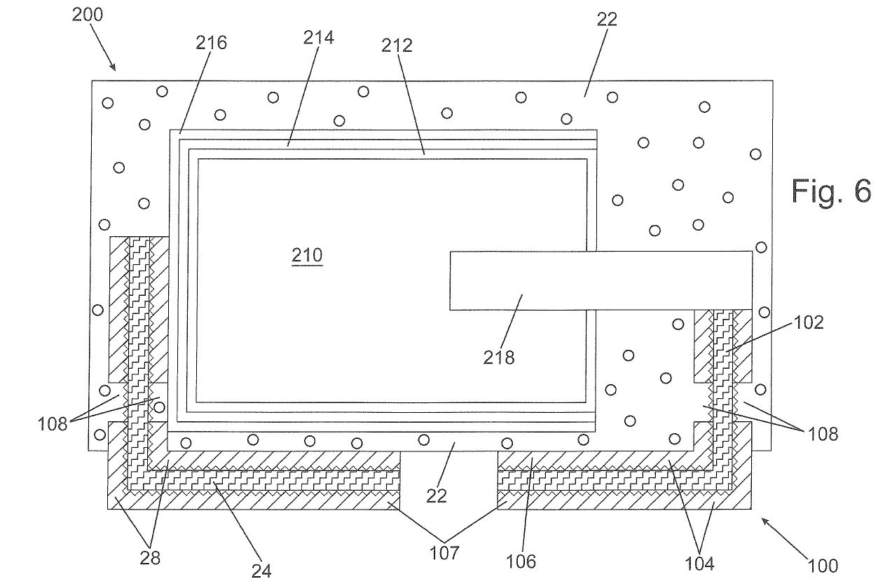

In FIG. 6, a capacitor, 200, comprises a capacitive element comprising an anode, 210, in the form of a pressed powder which is preferable a porous monolith formed by pressing a powder. An anode wire, 218, extends from the anode. The anode wire can be embedded in the powder prior to pressing, which is preferred, or the anode wire can be attached to the surface of the anode after pressing such as by welding. A dielectric, 212, encases at least a portion of the anode and preferably the entire anode. A cathode, 214, which is conductive, encompasses at least a portion of the dielectric with the understanding that the cathode and anode are separated by the dielectric and are not in direct contact. An optional, but preferred adhesion layer, 216, is provided to improve adhesion between the cathode and cathode lead as well understood in the art. The anode and cathode, with a dielectric therebetween, forms the capacitive couple as would be understood to those of skill in the art. A discontinuous anode lead is in electrical contact with the anode wire. The cathode is in electrical contact with a cathode lead, 24, comprising an optional but preferred discontinuous cathode surface coating and comprising a discontinuous region wherein the discontinuous region lacks the surface coating the function as discussed otherwise herein. An encasement, 22, encases at least a portion and preferably the entire capacitive couple and capacitor except for a terminal portion of the cathode lead and anode lead forming the lead frame. As would be understood the anode lead and cathode lead are collectively referred to as the lead frame, 107. In FIG. 6, the anode lead and cathode lead are illustrated and annotated differently for the purposes of discussion and clarity. In an embodiment the anode lead and cathode lead are separate portions collectively forming a lead frame and may be indistinguishable. When the anode lead and cathode lead are indistinguishable the discontinuous surface coating of each is substantially the same and the discontinuous region dimensions may be similar. As illustrated in FIG. 6 it is preferable that at least one of the anode lead or cathode lead of the lead frame, and preferably both, comprises a plurality of surface perturbations to increase surface area as described herein.

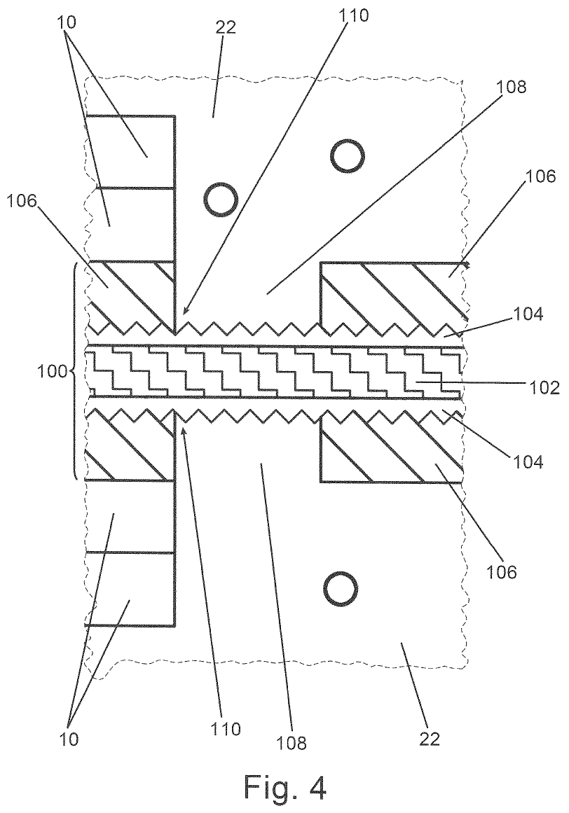

For purposes of clarity, a partial cross-sectional schematic view, indicated by the dotted box, is illustrated in FIG. 4 wherein the discontinuous anode lead portion of the lead frame can be more readily understood. The discontinuous anode lead, 100, comprises a metal base, 102. An optional but preferred primary metal layer, 104, which is preferably continuous, is on the discontinuous anode lead. The primary metal layer is provided to improve adhesion between the metal base and subsequent layers and may protect the metal base from corrosion and oxidation. A discontinuous surface layer, 106, is on the primary metal layer or metal base in the absence of a primary metal layer. The discontinuous surface layer comprises a discontinuous region, 108, which is an absence of the surface coating in the discontinuous surface layer, 106, wherein the layer immediately thereunder is exposed in the area of the discontinuous region. The discontinuous region initiates in the vicinity of the attachment point, 110, which is the termination of the overlap of the anode and anode lead, or contact region, and extends away from the attachment point and away from the overlap of the anode and anode lead.

The discontinuous region, in either the anode lead or cathode lead of the lead frame and preferably both the anode lead and cathode lead, eliminates the wicking or flowing of the discontinuous surface layer of the lead frame thereby eliminating the formation of a gap between the lead frame and encasement.

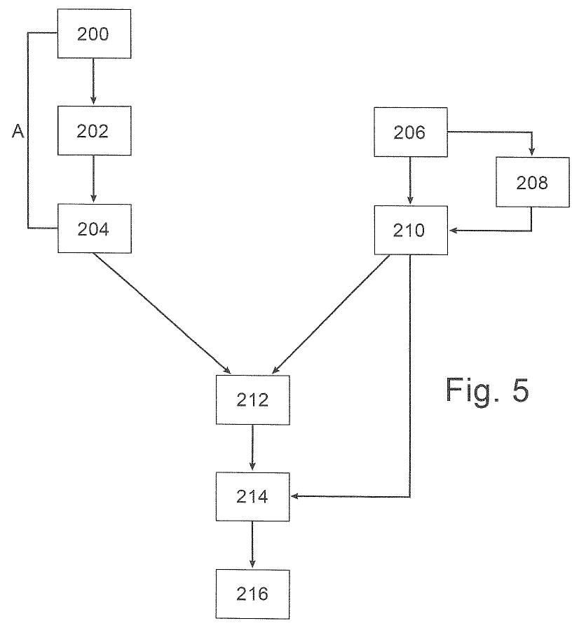

An embodiment of the invention will be described with reference to FIG. 5 wherein a method for forming the invention is provided in flow chart representation. In FIG. 5 an anode is provided at 200 and a dielectric is formed on the anode at 202. A cathode is formed on the dielectric at 204 covering a portion of the anode thereby forming a capacitive couple. The formation of capacitive couples can be repeated “A” times. An anode lead and a cathode lead are provided at 206 and are optionally etched at 208 followed by formation of a discontinuous region at 210 in the surface coating. The portions of multiple anodes, not covered with cathode, is bonded to anode lead with discontinuous region already formed, at 212. The cathode lead is electrically connected to the cathodes of each capacitive couple at 214 thereby forming a capacitor. As would be understood to those of skill in the art the anode lead and cathode lead may be components of a common lead frame and therefore steps 212 and 214 may be nearly simultaneous. The capacitor is encased in a resin at 216.

The method of discontinuous region formation is not particularly limited herein. The discontinuous region can be formed by mechanical serration, ablation, particularly laser ablation, chemical etching or by the formation of the discontinuous region using masking techniques with vapor deposition of the surface coating.

The junction region is that region wherein the anodes are electrically bonded to each other in a stack. The contact region is that region wherein the closest anode to the anode lead, or anodes if on opposite sides, is electrically bonded to the anode. It is preferable that the junction region be at least as long as the contact region since this provides maximum electrical contact area.

A discontinuous region length of at least 2 microns is preferred and more preferably at least 4 microns to no more than 40 microns and more preferably no more than 20 microns. A discontinuous region length extending beyond the point of egress of the lead frame from the encapsulant does not appreciably add to the benefit.

In the figures, the capacitor illustrates four capacitive couples for clarity. For most embodiments the capacitor preferably has at least one second capacitive couple and more preferably at least 2 capacitive couples to about 40 capacitive couples. The invention can be demonstrated with a very large number of capacitive couples. Above about 40 capacitive couples the capacitor size will not be convenient for surface mount applications and may become difficult from a manufacturing perspective. About 2-20 capacitive couples in a single capacitor is optimum. The anode lead is illustrated as being between adjacent capacitive couples and centrally located. It could be off center for packaging design consideration. This is for the purpose of illustration. The number of capacitive couples attached to either side of the anode lead is not limited and may be at least one capacitive couple on a side, with any other capacitive couples on the opposite side to all capacitive couples on the same side.

The anode is a conductor and most preferably a porous metal conductor preferably in the form of a foil or pressed and sintered powder. While not limited thereto valve metals, or conductive oxides of valve metals, are particularly suitable for demonstration of the invention. More preferably the anode comprises a valve metal, a mixture, alloy or conductive oxide of a valve metal wherein the valve metal is preferably selected from Al, W, Ta, Nb, Ti, Zr and Hf. The anode is preferably porous and in the form of a foil or a pressed and sintered powder. Most preferably the anode comprises aluminum or tantalum. The anode in the form of etched foil or a pressed and sintered powder with high surface area is preferred.

Etching of the anode, anode lead or cathode lead, can be done to form surface perturbations, such as by chemical etching, or by the formation of mechanical perturbations. Etching is preferably done by immersing the anode into at least one etching bath. Optionally an electric bias can be applied during etching. Various etching baths are taught in the art and the method used for etching the anode, anode lead or cathode lead, is not limited herein.

A particularly preferred anode material for a pressed powder anode is a metal and a particularly preferred metal is a valve metal or a conductive oxide of a valve metal. Particularly preferred pressed powder anodes comprise a material selected from the group consisting of niobium, aluminum, tantalum and NbO. Tantalum is the most preferred anode material. Preferred are high charge density powders such as above 50,000 CV/g. Particularly preferred powders have a charge density above 100,000 CV/g, preferably above 200,000 CV/g and even more preferably above about 250,000 CV/g up to about 350,000 CV/g.

The anode wire is either embedded in or attached to the anode with a preference for an embedded anode wire. The material of construction for the anode wire is not particularly limited, however, it is preferable that the anode wire be the same material as the anode for manufacturing conveniences.

A dielectric is formed on the surface of the anode and preferably an etched, or roughened, surface of the anode to increase surface area. The dielectric is a non-conductive layer which is not particularly limited herein and consistent with those widely used in the art. The dielectric may be a metal oxide or a ceramic material. A particularly preferred dielectric is the oxide of the metal used for the anode due to the simplicity of formation and ease of use. The dielectric layer is preferably an oxide of the valve metal as further described herein. The dielectric is preferably formed by immersing the anode into an electrolyte solution and applying a positive voltage to the anode. Electrolytes for the oxide formation are not particularly limiting herein but exemplary materials can include ethylene glycol; polyethylene glycol dimethyl ether solutions in water as described in U.S. Pat. No. 5,716,511; alkanolamines and phosphoric acid, as described in U.S. Pat. No. 6,480,371; polar aprotic solvent solutions of phosphoric acid as described in U.K. Pat. No. GB 2,168,383 and U.S. Pat. Nos. 5,185,075; 6,475,368 teaches anodization with alpha-hydroxy acid and U.S. Pat. No. 6,475,368 teaches reel aluminum anodization or the like. Electrolytes for formation of the dielectric on the anode including aqueous solutions of dicarboxylic acids, such as ammonium adipate are also known. Other materials may be incorporated into the dielectric such as phosphates, citrates, etc. to impart thermal stability or chemical or hydration resistance to the dielectric layer.

The cathode layer is a conductive layer preferably comprising conductive polymer, such as polythiophene, polyaniline, polypyrrole or their derivatives; manganese dioxide, lead oxide or combinations thereof. An intrinsically conducting polymer is most preferred. The polymer can be applied by any technique commonly employed in forming layers on a capacitor including dipping, spraying oxidizer, dopant and monomer onto the anodized pellet or foil, allowing the polymerization to occur for a set time, and ending the polymerization with a wash. The polymer can also be applied by electrolytic deposition as well known in the art.

The cathode can be applied as a polymer layer or the polymer can be formed in situ by applying oxidizers and monomers preferably by sequential dipping optionally with wetting agents or by pressure changes to improve the migration of the monomer and/or oxidizer into the interstitial areas of the anode. In a particularly preferred embodiment each anode, collectively or individually, is dipped in an oxidizer whereby oxidizer is deposited on the surface of the dielectric followed by dipping in a monomer solution wherein monomer migrates into the interstitial spaces to be polymerized by the oxidizer. The monomer may be applied first with oxidizer added thereafter. Repeating the alternate application of monomer and oxidizer is preferred to insure that as much of the interstitial space is filled as possible. Application of polymer, either prior to the application of monomer or after formation of polymer from monomer, is contemplated. It is preferable to undergo a reform step after polymer formation as known in the art.

A particularly preferred conducting polymer is illustrated in Formula A:

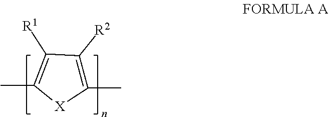

wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements. R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n represents that the compound of Formula A is a polymer with a range of molecular weights; in general n is an integer of 2 to a number sufficient to reach an average molecular weight of about 500,000.

R¹ and R² of Formula A are preferably chosen to prohibit polymerization at the β-sites of the ring as it is most preferred that only α-site polymerization be allowed to proceed. It is more preferred that R¹ and R² are not hydrogen and more preferably, R¹ and R² are α-directors with ether linkages being preferable over alkyl linkages. It is most preferred that the R¹ and R² are small to avoid steric interferences.

In a particularly preferred embodiment R¹ and R² of Formula A are taken together to represent —O—(CHR⁴)ₘ—O— wherein m is an integer from 1 to 5 and most preferably 2; each R⁴ is independently selected from hydrogen, a linear or branched C₁ to C₁₈ alkyl radical C₅ to C₁₂ cycloalkyl radical, C₆ to C₁₄ aryl radical C₇ to C₁₈ aralkyl radical or C₁ to C₄ hydroxyalkyl radical, optionally substituted with a functional group capable of providing self-doping functionality and particularly those selected from carboxylic acid, hydroxyl, amine, substituted amines, alkene, acrylate, thiol, alkyne, azide, sulfate, sulfonate, sulfonic acid, imide, amide, epoxy, anhydride, silane, and phosphate; hydroxyl radical; or R⁴ is selected from —(CHR⁵)ₐ—R¹⁶; —O(CHR⁵)ₐR¹⁶; —CH₂O(CHR₅)ₐR¹⁶; —CH₂O(CH₂CHR₅O)ₐR¹⁶, or R⁴ is a functional group selected from the group consisting of hydroxyl, carboxyl, amine, epoxy, amide, imide, anhydride, hydroxymethyl, alkene, thiol, alkyne, azide, sulfonic acid, benzene sulfonic acid sulfate, SO₃M, anhydride, silane, acrylate and phosphate;

R⁵ is H or alkyl chain of 1 to 5 carbons optionally substituted with functional groups selected from carboxylic acid, hydroxyl, amine, alkene, thiol, alkyne, azide, epoxy, acrylate and anhydride. R¹⁶ is H, —SO₃M or an alkyl chain of 1 to 5 carbons optionally substituted with functional groups selected from carboxylic acid, hydroxyl, amine, substituted amines, alkene, thiol, alkyne, azide, amide, imide, sulfate, SO₃M, amide, epoxy, anhydride, silane, acrylate and phosphate. a is integer from 0 to 10. M is a H or cation preferably selected from ammonia, sodium or potassium.

A particularly preferred polymer is 3,4-polyethylene dioxythiophene (PEDOT) which is prepared from monomeric 3,4-ethylene dioxythiophene (EDOT).

Particularly preferred conductive polymers include poly(3,4-ethylenedioxythiophene), poly(4-(2,3-dihydrothieno-[3,4-b][1,4]dioxin-2-yl) methoxy)-1-butane-sulphonic acid, salt), poly(4-(2,3-dihydrothieno-[3,4-b][1,4]dioxin-2-yl) methoxy)-1-propane-sulphonic acid, salt), poly(4-(2,3-dihydrothieno-[3,4-b][1,4]dioxin-2-yl) methoxy)-1-methyl-1-propane-sulphonic acid, salt), poly(4-(2,3-dihydrothieno-[3,4-b][1,4]dioxin-2-yl) methoxy alcohol, poly(N-methylpyrrole), poly(3-methylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), polythiophene, poly(3-methylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-ethylenedioxythiophene), poly(3,4-propylenedioxythiophene), poly(3,4-butenedioxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-aniline sulfonate), poly(3-aniline sulfonate), and the like.

Particularly suitable polymers or co-polymers are selected from the group consisting of poly(4-(2,3-dihydrothieno-[3,4-b][1,4]dioxin-2-yl) methoxy)-1-butane-sulphonic acid, salt), poly(4-(2,3-dihydrothieno-[3,4-b][1,4]dioxin-2-yl) methoxy)-1-methyl-1-propane-sulphonic acid, salt), poly(N-methylpyrrole), poly(3-methylthiophene), poly(3-methoxythiophene), and poly(3,4-ethylenedioxythiophene). Preferred polyanions are described in U.S. Pat. No. 10,340,091 with polystyrene sulfonate being particularly preferred.

If a manganese dioxide layer is used the manganese dioxide layer is preferably obtained by immersing the stacked anodes in an aqueous manganese nitrate solution. The manganese oxide is then formed by thermally decomposing the nitrate at a temperature of from 200 to 350° C. in a dry or steam atmosphere. The anode may be treated multiple times to insure optimum coverage.

As typically employed in the art, various dopants can be incorporated into the polymer during the polymerization process or post treatment. Dopants can be derived from various acids or salts, including aromatic sulfonic acids, aromatic polysulfonic acids, organic sulfonic acids with hydroxy group, organic sulfonic acids with carboxylhydroxyl group, alicyclic sulfonic acids and benzoquinone sulfonic acids, benzene disulfonic acid, sulfosalicylic acid, sulfoisophthalic acid, camphorsulfonic acid, benzoquinone sulfonic acid, dodecylbenzenesulfonic acid, toluenesulfonic acid. Other suitable dopants include sulfoquinone, anthracenemonosulfonic acid, substituted naphthalenemonosulfonic acid, substituted benzenesulfonic acid or heterocyclic sulfonic acids.

Binders and cross-linkers can be also incorporated into the conductive polymer layer if desired. Suitable materials include poly(vinyl acetate), polycarbonate, poly(vinyl butyrate), polyacrylates, polymethacrylates, polystyrene, polyacrylonitrile, poly(vinyl chloride), polybutadiene, polyisoprene, polyethers, polyesters, silicones, and pyrrole/acrylate, vinylacetate/acrylate and ethylene/vinyl acetate copolymers, epoxy based polymers.

It is preferred to include a dopant in the polymer. The dopant can be applied separately or included in the oxidizer solution. Dopants are well known in the art and not limited herein.

The anodes are preferably attached to the anode lead by welding. The metal base of the anode lead is a conductor and most preferably a metal conductor comprising copper, iron, nickel, chromium and alloys. Particularly suitable materials for use as a metal base comprise alloy 194, alloy 752, alloy 42, stainless steels. The anode lead is preferably plated with other metals to improve solderability onto the circuit trace. In a particularly preferred embodiment an optional primary metal layer is plated onto the anode lead prior to the plating of the surface coating which will ultimately be the discontinuous surface coating. While not limited thereto valve metals, or conductive oxides of valve metals, are particularly suitable for demonstration of the invention.

The primary metal layer preferably comprises metals with nickel, iron, chromium, copper, and their alloys.

A particularly preferred discontinuous surface coating comprises tin or its alloys with other metals such as Pb. The discontinuous surface coating is a layer which is suitable for soldering. A particularly preferred discontinuous surface coating comprises any metal or metallic alloy with melting point below 260° C.

In the figures the cathode lead and anode lead of the lead frame are illustrated as being between adjacent capacitive couples and centrally located. This is for the purpose of illustration. The number of capacitive couples attached to either side of the lead frame is not limited and may be from one capacitive couple to all capacitive couples.

The resin used for the encasement is not particularly limited herein with the understanding that the resin is preferably electrically insulating. Any resins typically utilized in the art are suitable for demonstration of the invention.

As is well known in the art, adhering adjacent polymeric cathodes to each other, or to a cathode lead is difficult. To enhance connectivity to adjacent cathodes and to the cathode lead it is preferable to provide adhesion layers to the conductive polymer layer. The adhesion layers typically include a carbon containing layer on the conductive polymer layer and a metal containing layer, such as a silver containing layer, on the carbon layer. The layers are formed by dipping, coating, painting, electroplating or by deposition such as by vapor phase deposition.

The invention has been described with reference to preferred embodiments without limit thereto. One of skill in the art would realize additional embodiments which are described and set forth in the claims appended hereto.

1. A capacitor comprising:
a first capacitive couple comprising a first dielectric on a first anode and a first cathode on said first dielectric;
a lead frame comprising a discontinuous surface coating wherein said discontinuous surface coating comprises a contact region and a discontinuous region;
wherein at least one of said first anode or said first cathode is in electrical contact at said contact region; and
an encapsulant in contact with said discontinuous region.

2. The capacitor of claim 1 wherein said first anode is in electrical contact with said contact region.

3. The capacitor of claim 1 wherein said first cathode is in electrical contact with said contact region.

4. The capacitor of claim 1 wherein said lead frame comprises surface perturbations.

5. The capacitor of claim 4 wherein said surface perturbations are in said discontinuous region.

6. The capacitor of claim 1 comprising a second capacitive couple comprising a second anode and a second cathode wherein at least one of said second anode or said second cathode is in electrical contact with a second contact region.

7. The capacitor of claim 6 comprising up to 40 capacitive couples.

8. The capacitor of claim 7 comprising up to 2-20 capacitive couples.

9. The capacitor of claim 1 wherein said discontinuous region initiates at an attachment point wherein said attachment point is a termination of said contact region and extends away from said contact region.

10. The capacitor of claim 1 wherein said discontinuous region extends a length of at least 2 microns to no more than 40 microns.

11. The capacitor of claim 1 wherein said discontinuous surface coating comprises any metal or metallic alloy with melting point below 260° C.

12. The capacitor of claim 1 wherein said lead frame comprises a metal base.

13. The capacitor of claim 12 wherein said metal base comprises copper, ion, nickel, chromium, and their alloys.

14. The capacitor of claim 13 wherein said metal base comprises alloy 194, alloy 752, alloy 42, stainless steels.

15. The capacitor of claim 1 wherein said anode lead comprises a primary metal layer with said discontinuous surface coating on said primary metal layer.

16. The capacitor of claim 15 wherein said primary metal layer comprises nickel, iron chromium, copper and their alloys.

17. The capacitor of claim 15 wherein said discontinuous surface coating comprises any metal or metallic alloy with melting point below 260° C.

18. The capacitor of claim 15 wherein said discontinuous surface coating comprises tin or a tin alloy.

19. The capacitor of claim 18 wherein said tin alloy comprises lead.

20. The capacitor of claim 1 wherein said anode comprises a metal.

21. The capacitor of claim 20 wherein said anode comprises a valve metal.

22. The capacitor of claim 21 wherein said anode is preferably selected from the group consisting of AI, W, Ta, Nb, Ti, Zr and Hf.

23. The capacitor of claim 22 wherein said anode comprises aluminum.

24. The capacitor of claim 22 wherein said anode comprises tantalum.

25. The capacitor of claim 20 wherein said anode is a foil.

26. The capacitor of claim 20 wherein said anode is etched.

27. The capacitor of claim 20 wherein said anode comprises a sintered pressed powder.

28. The capacitor of claim 1 wherein said cathode comprising a conductive polymer or manganese dioxide.

29. The capacitor of claim 28 wherein said conductive polymer is selected from the group consisting of a polythiophene, a polyaniline and a polypyrrole and their derivatives.

30. The capacitor of claim 29 wherein said conducting polymer is defined by Formula I: 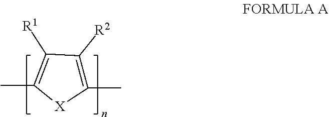
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

31. The capacitor of claim 29 wherein said conducting polymer is 3,4-polyethylene dioxythiophene.

32. A method for forming capacitor comprising:
forming a first capacitive couple comprising a first dielectric on a first anode and a first cathode on said first dielectric;
providing a lead frame comprising a discontinuous surface coating wherein said discontinuous surface coating comprises a contact region and a discontinuous region;
electrically connecting said first anode or said first cathode to said contact region; and
encapsulating said capacitive couple with an encapsulant wherein said encapsulant is in contact with said lead frame at said discontinuous region.

33. The method of forming a capacitor of claim 32 comprising electrically connecting said first anode to said contact region.

34. The method of forming a capacitor of claim 32 comprising electrically connecting said first cathode to said contact region.

35. The method of forming a capacitor of claim 32 wherein said lead frame comprises surface perturbations.

36. The method of forming a capacitor of claim 35 wherein said surface perturbations are in said discontinuous region.

37. The method of forming a capacitor of claim 32 further comprising forming a second capacitive couple with a second anode and electrically connecting said second anode to said first anode in a junction region.

38. The method of forming a capacitor of claim 37 comprising forming up to 40 capacitive couples.

39. The method of forming a capacitor of claim 38 comprising forming up to 2-20 capacitive couples.

40. The method of forming a capacitor of claim 32 wherein said discontinuous region initiates at an attachment point wherein said attachment point is a termination of said contact region and extends away from said contact region.

41. The method of forming a capacitor of claim 32 wherein said discontinuous region extends a length of at least 2 microns to no more than 40 microns.

42. The method of forming a capacitor of claim 32 wherein said discontinuous surface coating comprises any metal or metallic alloy with melting point below 260° C.

43. The method of forming a capacitor of claim 32 wherein said discontinuous surface coating comprises tin or a tin alloy.

44. The method of forming a capacitor of claim 43 wherein said tin alloy comprises lead.

45. The method of forming a capacitor of claim 32 wherein said anode lead comprises a metal base.

46. The method of forming a capacitor of claim 45 wherein said metal base comprises copper, ion, nickel, chromium, and their alloys.

47. The capacitor of claim 46 wherein said metal base comprises alloy 194, alloy 752, alloy 42, stainless steels.

48. The method of forming a capacitor of claim 32 wherein said anode lead comprises a primary metal layer with said discontinuous surface coating on said primary metal layer.

49. The method of forming a capacitor of claim 48 wherein said primary metal layer comprises nickel, iron, chromium, copper and their alloys.

50. The method of forming a capacitor of claim 32 wherein said cathode lead comprises a discontinuous surface coating.

51. The method of forming a capacitor of claim 32 wherein said anode comprises a metal.

52. The method of forming a capacitor of claim 51 wherein said anode comprises a valve metal.

53. The method of forming a capacitor of claim 52 wherein said anode is preferably selected from the group consisting of AI, W, Ta, Nb, Ti, Zr and Hf.

54. The method of forming a capacitor of claim 53 wherein said anode comprises aluminum.

55. The method of forming a capacitor of claim 53 wherein said anode comprises tantalum.

56. The method of forming a capacitor of claim 51 further wherein said anode is a foil.

57. The method of forming a capacitor of claim 51 wherein said anode is etched.

58. The method of forming a capacitor of claim 51 further comprising pressing a powder of said metal into a monolith and sintering to form said anode.

59. The method of forming a capacitor of claim 32 wherein said cathode comprising a conductive polymer or manganese dioxide.

60. The method of forming a capacitor of claim 59 wherein said conductive polymer is selected from the group consisting of a polythiophene, a polyaniline and a polypyrrole.

61. The method of forming a capacitor of claim 60 wherein said conducting polymer is defined by Formula I: 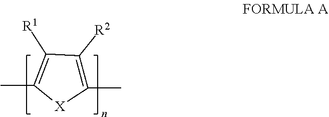
wherein:
R¹ and R² independently represent linear or branched C₁-C₁₆ alkyl, C₂-C₁₈ alkoxyalkyl C₃-C₈ cycloalkyl, phenyl or benzyl which are unsubstituted or substituted by C₁-C₆ alkyl, C₁-C₆ alkoxy, halogen or OR³; or
R¹ and R², taken together, are linear C₁-C₆ alkylene which is unsubstituted or substituted by C₁-C₆ alkyl, C₁-C₆ alkoxy, halogen, C₃-C₈ cycloalkyl, phenyl, benzyl, C₁-C₄ alkylphenyl, C₁-C₄ alkoxyphenyl, halophenyl, C₁-C₄ alkylbenzyl, C₁-C₄ alkoxybenzyl or halobenzyl, 5-, 6-, or 7-membered heterocyclic structure containing two oxygen elements;
R³ represents hydrogen, linear or branched C₁-C₁₆ alkyl or C₂-C₁₈ alkoxyalkyl, C₃-C₈ cycloalkyl, phenyl or benzyl which are unsubstituted or substituted by C₁-C₆ alkyl;
X is S; and
n is an integer of 2 to a number sufficient to reach an average molecular weight of about 500,000.

62. The method of forming a capacitor of claim 60 wherein said conducting polymer is 3,4-polyethylene dioxythiophene.
